(19) United States
(12) Patent Application Publication
(10) Pub. No.: US 2015/0072851 A1
(43) Pub. Date: Mar. 12, 2015

(54) CENTRIFUGAL SEPARATOR WITH CIRCULAR ROTOR BLADES

(71) Applicant: CENTRIFUGAL AND MECHANICAL INDUSTRIES, LLC, St. Louis, MO (US)

(72) Inventors: Gregory Alan Wirtel, St. Louis, MO (US); Kevin Ray Whisler, St. Louis, MO (US)

(73) Assignee: CENTRIFUGAL AND MECHANICAL INDUSTRIES, LLC, St. Louis,, MO (US)

(21) Appl. No.: 14/388,398

(22) PCT Filed: Mar. 26, 2013
(86) PCT No.: PCT/US2013/033874

§ 371 Date: Sep. 26, 2014

Related U.S. Application Data
(63) Continuation-in-part of application No. 13/836,284, filed on Mar. 15, 2013.
(60) Provisional application No. 61/615,541, filed on Mar. 26, 2012.

(51) Int. Cl. B04B 7/08; B01D 21/26; B04B 7/16; B04B 3/00

(52) U.S. Cl. CPC B04B 7/08; B04B 3/00; B01D 21/262; B04B 7/16
USPC 494/36; 494/37

(57) ABSTRACT

An improved centrifugal separator system and method for separating a solid portion from a liquid portion, of the type including a chute for introducing material into the separator; a screen rotated on a shaft for allowing a liquid portion of the material to flow through the screen but preventing solids from flowing through the screen; a space between the housing and the screen for allowing the solids to travel through the separator; a rotor portion, further comprising a plurality of blades radiating outward from a hub portion of the rotor to an outer ring portion of the rotor to define the traveling space for the solid material between the rotor blades; wherein each of the blades being circular in cross section along their length to minimize the impact on the solid material which makes contact with the rotating blades and do less damage to the solid material, resulting in better product and a reduction in the energy required to power the separator.

### CROSS-REFERENCE TO RELATED APPLICATIONS

In the US, this is a continuation-in-part of U.S. patent application Ser. No. 13/836,284, filed on 15 Mar. 2013, which was a nonprovisional patent application of U.S. Provisional Patent Application Ser. No. 61/615,541, filed 26 Mar. 2012, both of which are hereby incorporated herein by reference.

Priority of U.S. patent application Ser. No. 13/836,284, filed on 15 Mar. 2013, and U.S. Provisional Patent Application Ser. No. 61/615,541, filed 26 Mar. 2012, which are incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to centrifugal separator systems. More particularly, the present invention relates to an improved centrifugal separator having rotor blades which are circular in cross-section.

2. General Background

In certain industries, centrifugal separators are used to separate liquids from solids in rather large volumes. For example, in the coal industry, often times coal is mined and is transported in a slurry form. In this form, the solid coal must be separated from the liquid portion of the slurry. This separation process is usually accomplished with the use of a centrifugal separator, where the slurry is passed through the separator and the solid coal is separated from the liquid.

One of the drawbacks of this type of separator system is that the solid coal, as it travels through the separator, must past through openings of a rotating rotor to reach its final destination. In the present state of the art, as the coal is traveling through the spaces between the rotor blades, the rotor is rotating at a certain speed, and the blades make contact with chunks of coal as it travels through. In the current state of the art, rotor blades are substantially flat or rectangular in shape, thereby having the walls of the blade at right angles to one another. Therefore, when the flat sides of the blade body make contact with chunks of coal, the contact often results in the coal being fractured into smaller pieces upon impact by the rotor blades. This direct contact between the coal and the blade also requires that the separator utilize additional energy to carry out its operation. These are not desired results. Therefore, there is a need in the industry for a separator which is less expensive to manufacture; which minimizes the fracturing of coal chunks into small pieces should contact be made by the circular rotating rotor blades on the coal, which results in the consumption of less energy to carry out the separation operation.

### SUMMARY OF THE PRESENT INVENTION

The system of the present invention solves the problems in the art in a simple and straightforward manner.

What is provided is an improved centrifugal separator system and method for separating a solid portion from a liquid portion, of the type including a chute for introducing material into the separator; a screen rotated on a shaft for allowing a liquid portion of the material to flow through the screen but preventing solids from flowing through the screen; a space for allowing the solids to travel through the separator; a rotor portion, further comprising a plurality of blades radiating outward from a hub portion of the rotor to an outer ring portion of the rotor to define the traveling space for the solid material between the rotor blades; wherein each of the blades being circular in cross section along their length to minimize the impact on the solid material which makes contact with the rotating blades and reduces the fractures to the solid material, resulting in better product and a reduction in the energy required to power the separator.

It has been determined in testing that when the rotor blades are circular in cross-section, rather than having angular corners, impact with chunks of coal does not result in the coal being fractured into as many smaller pieces, which results in more coal pieces remaining intact, and because of the minimal contact, the system runs more efficiently, with a reduction in the amount of power to run the system.

Therefore, it is the principal object of the present invention to provide a separator system having an improved rotor with spokes or blades being circular in cross-section rather than flat, so as to reduce the fracturing of chunks of coal making contact with the blades as the coal travels through the rotor during the separation process.

It is the further principal object of the present invention to provide a centrifugal separator which includes a rotor having rotor blades which are circular in cross-section, thus reducing the impact of the blades on material, such as coal, traveling through the rotor, creating less wind from the rotor blades rotation, and also resulting in a more efficient, less energy intensive, system.

It is a further object of the present invention to provide a centrifugal separator which, because of the circular blades or spokes, is less expensive to manufacture, and which consumes less energy during operation.

Another object of the invention is to provide a centrifugal separator system wherein a wide range of solid material, other than coal, may be introduced for separation.

One embodiment of the system of the present invention is an improved centrifugal separator system for separating a solid portion from a liquid portion, of the type including a chute for introducing material into the separator; a screen rotated on a shaft for allowing a liquid portion of the material to flow through the screen but preventing solids from flowing through the screen; a space for allowing the solids to travel through the separator; a rotor portion, further comprising a plurality of blades radiating outward from a hub portion of the rotor to an outer ring portion of the rotor to define the traveling space for the solid material between the rotor blades; wherein each of the blades being circular in cross section along their length to minimize the impact on the solid material which makes contact with the rotating blades and reduces the fractures to the solid material, resulting in better product and a reduction in the energy required to power the separator.

In another embodiment of the system of the present invention, the material to be separated is coal suspended in a slurry or with other solids having a wet surface.

In another embodiment of the system of the present invention, the rotor and screen rotate between 200 and 2000 revolutions per minute (“RPM”) (3.34 to 33.34 hertz).

In another embodiment of the system of the present invention, the separator utilizes less energy due to the reduction of impact between the solid material and the circular wall of the rotor blades.

In another embodiment of the system of the present invention, the blades of the rotor radiate at a right angle from a hub portion of the rotor to an outer ring portion of the rotor to define the traveling space for the solid material between the rotor blades.

In another embodiment of the system of the present invention, the blades of the rotor radiate at an oblique angle from a hub portion of the rotor to an outer ring portion of the rotor to define the traveling space for the solid material between the rotor blades.

In another embodiment of the system of the present invention the material may comprise any material that could be separated from a liquid, such as various minerals, oil field cuttings and other types of solids.

In one embodiment of the method of the present invention, the method comprises separating solid coal from a liquid portion in a slurry, comprising the following steps: providing a centrifugal separator; introducing the coal slurry into the separator; routing the slurry to a rotating screen in the separator allowing the liquid portion of the material to flow through the screen but preventing the solid coal from flowing through the screen; providing a rotor portion, which further comprises a plurality of spaced apart blades, each of the blades being circular in cross section along their length; and flowing the solid coal through the spaces between the blades of the rotating rotor in the separator, so that the circular walls of the blades minimize the impact on the solid coal which makes contact with the rotating blades to reduce or eliminate fracturing to the pieces of solid coal.

In another embodiment of the method of the present invention, the rotor and screen are rotating at approximately 200 to 1300 RPM (3.34 to 21.67 hertz).

In another embodiment of the method of the present invention the blades being circular in cross section results in the utilization of less energy due to the reduction of impact between the solid coal and the circular wall of the rotor blades.

In another embodiment of the method of the present invention the material to be separated may be solid coal having moisture on its surface or the material may comprise any material that could be separated from a liquid, such as various minerals, oil field cuttings and other types of solids.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 illustrates in cross-section the centrifugal separator of the present invention with the improved rotor mounted thereon;

FIGS. 2A through 2E illustrate various views of a first embodiment of the improved rotor blade with the blades or spokes extending outward from the hub of the rotor at a right angle from the hub wall;

FIGS. 3A through 3E illustrate various views of a second embodiment of the improved rotor blade with the blades or spokes extending outward from the hub of the rotor at less than a right angle from the hub wall;

FIG. 4 illustrates a cross-section view of the blade of the rotor of the present invention; and

FIGS. 5A and 5B illustrate views of the spokes radiating out from the hub of the rotor with no ring engaging the spokes at their terminal ends.

### DETAILED DESCRIPTION OF THE PREFERRED EMBODIMENT

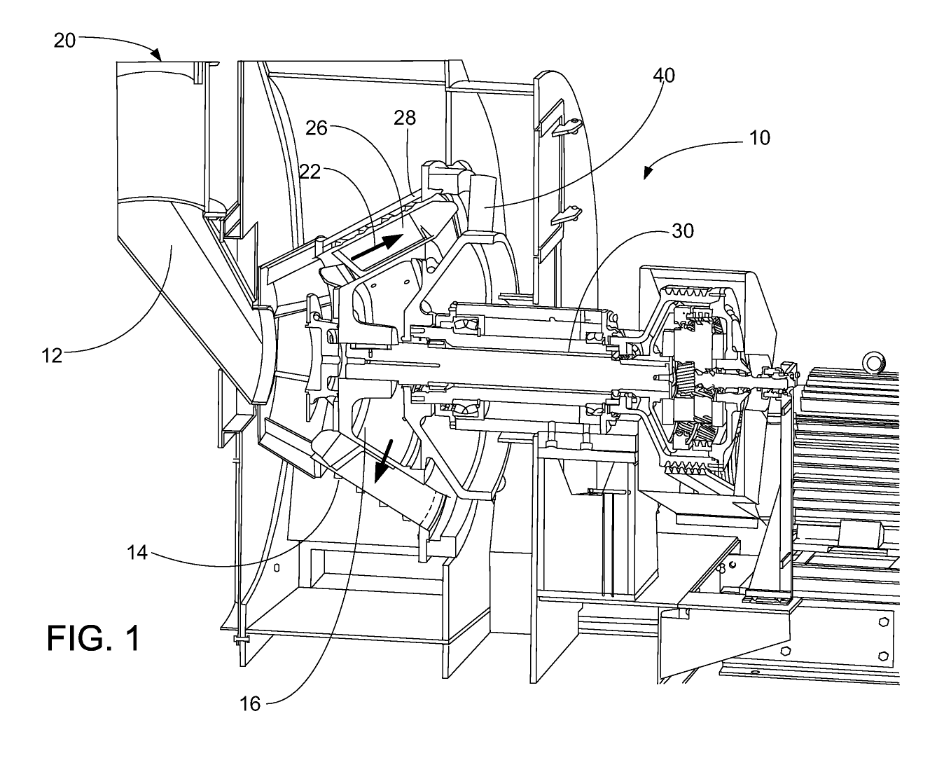

FIGS. 1 through 5B illustrate a preferred embodiment of the system of the present invention designated generally by the numeral 10. Before describing the nature of the present invention, it should be made clear that centrifugal separator 10 as seen and described is similar in most respects to centrifugal separators found in the art, for example, in U.S. Pat. No. 5,720,879, owned by Elgin National Industries, Inc. The nature of the present invention over the prior is discussed below.

In FIG. 1, there is illustrated the preferred embodiment of the centrifugal separator 10 of the present invention. Separator 10 includes a hopper 12 into which the material (slurry 20) to be separated enters the separator 10. For purposes of this application, the material will be described as coal in a slurry form, as an example, although other types of material may be subject to separation. An example of other material that may be introduced into hopper 12 is solid coal having a wet surface. Additionally, the material entering through hopper 12 may comprise any material that could be separated from a liquid, such as various minerals, oil field cuttings and other types of solids.

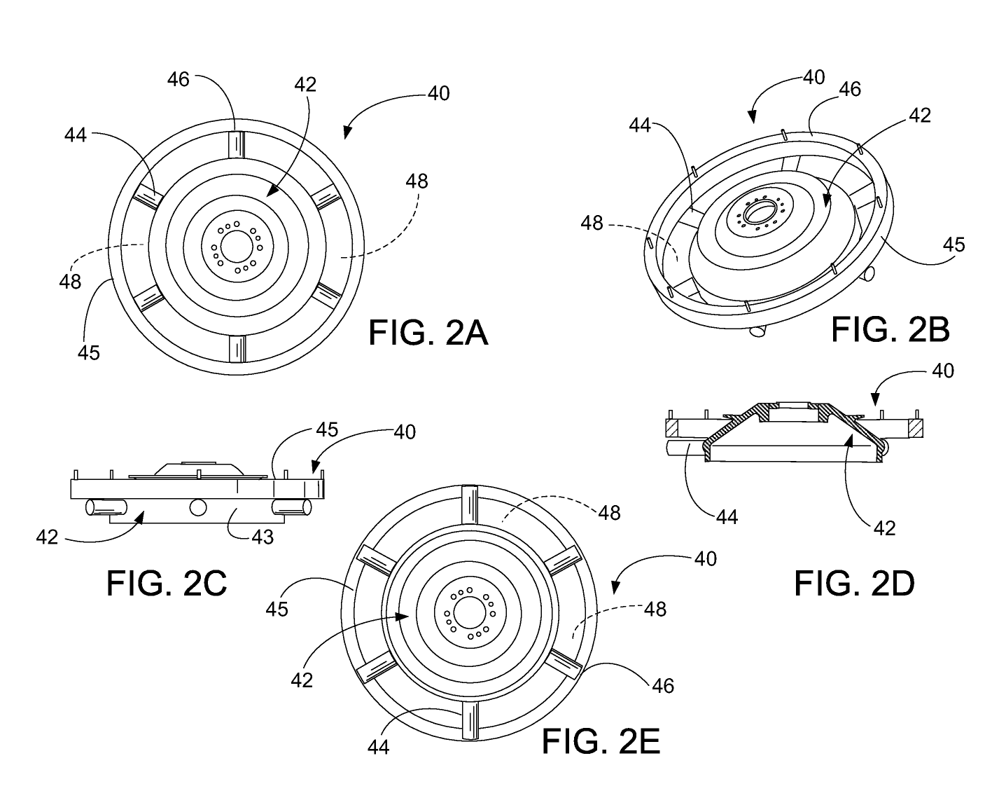

During operation separator 10 further provides a screen 14 at the lower end of the hopper 12 through which the liquid portion (arrow 16) will travel through to be routed to its final destination. Screen 14 will be rotating on outer shaft 30. The solid portion (arrow 22) of the slurry 20 will be forced to travel through the circular space 26 along the outer wall 28 of the screen 14, and reach the rear of screen 14 where there is mounted a rotor 40, also rotating on outer shaft 30. The rotor 40 is constructed, as seen in FIGS. 2A-2E, with a central hub portion 42 and a plurality of spaced apart spokes or blades 44 radiating out from hub 42 to an outer ring 45 where the distal ends 46 of each spoke are mounted. There is defined a space 48 between blades 44, the function of which will be described further. As in all separators, the construction of hub 42, as defined so far, is quite typical in centrifugal separators.

FIGS. 2A through 4 define the improvements of the present invention over the prior art. As illustrated, each of the spokes or blades 44 are circular in cross-section, as seen in cross section view in FIG. 4, where there is defined a circular wall 50, which, by its construction, has no right angular corners as seen in the prior art with flat blade construction. Arrow 60 in FIG. 4 illustrates the path of the coal as it would be traveling through the spaces 48 between each of the blades 44, without contacting the blades 44, while arrow 62 illustrates other pieces of coal making contact with the circular walls 50 of blades 44.

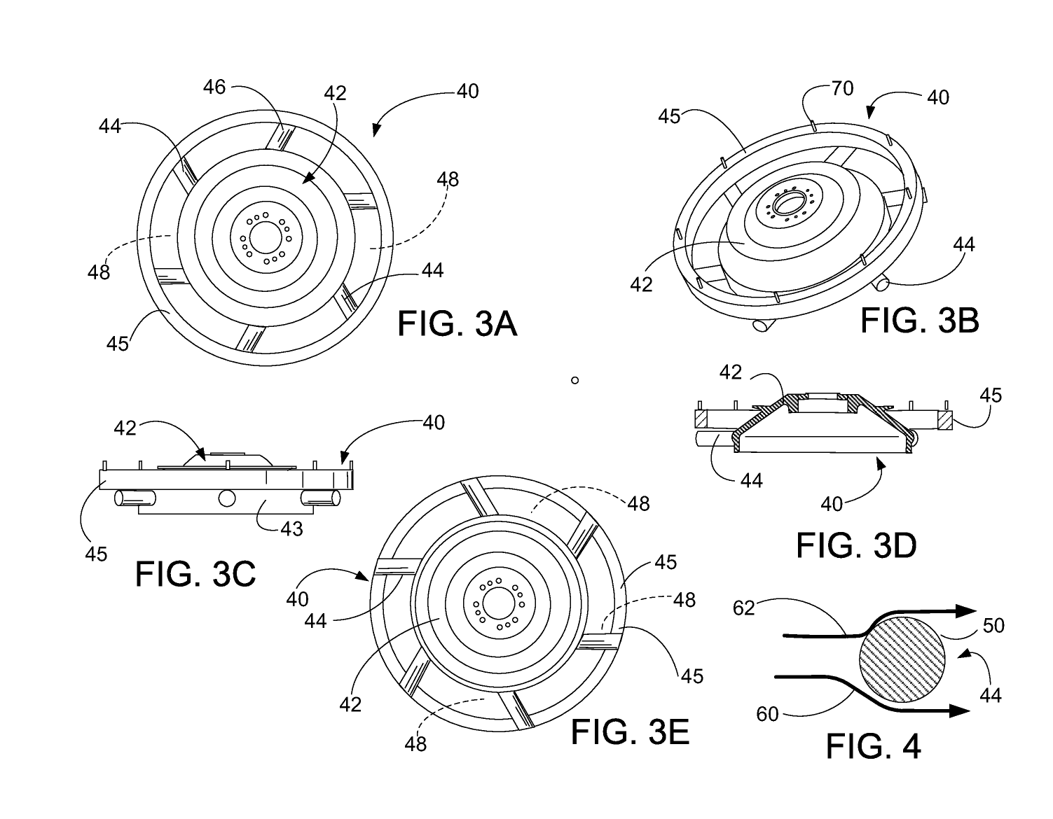

The circular wall construction of the blades 44 is critical, since in operation, the coal must travel through each of the spaces 48 between the spokes or blades 44, while the rotor 40 is rotating at approximately 200 to 2000 RPM (3.34 to 33.34 hertz), to reach its final destination. (The optimum speed would be approximately 600 RPM (10 hertz)). In doing so, it is inevitable that the rotating rotor blades 44 will make direct contact with chunks of coal during their travel through the spaces 48 of rotor 40. The circular wall 50 of each spoke 44 has been found to reduce significantly the impact that the circular spokes 44 have on the coal chunks as compared to the flat spokes of the prior art. A significantly less amount of coal is fractured, which results in a coal product that is not broken into small pieces. Further, because the impact on the coal is less with the circular blades 44, the separator requires less energy to run during the separation process. It should be noted that FIGS. 2A-2E illustrate the spokes 44 emanating from the wall 43 of hub portion 42 at a right angle from wall 43, while FIGS. 3A-3E illustrate the spokes 44 emanating at an angle less than a right angle from wall 43 of hub portion 42. These two designs are being experimented to determine the most efficient design to utilize to reach the goals of reducing the impact on the coal and saving energy.

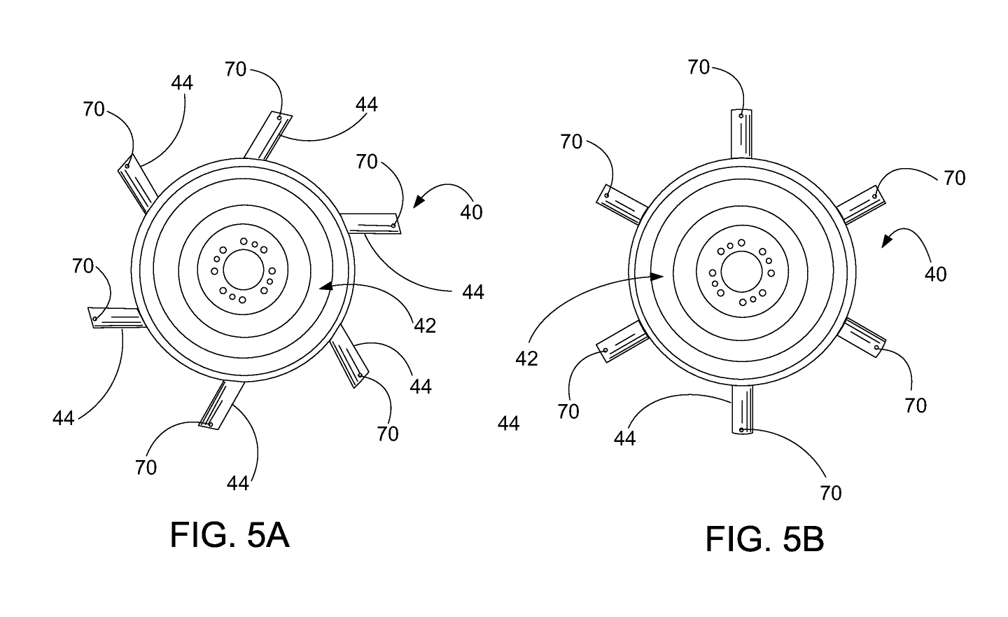

FIGS. 5A and 5B illustrate another embodiment of the rotor 40 from which the spokes 44 radiate outward. As illustrated in FIG. 5A, the spokes 44 are radiating outward at an oblique angle from the rotor hub portion 42, while in FIG. 5B the spokes 44 radiate outward at a right angle from the rotor hub portion 42. In both views, there is no outer ring 45 which the ends of the rotors attach to as in earlier embodiments. There is positioned a post, peg or stud 70 at the end of each spoke 44, as illustrated, with the posts 70 positioned preferably about 1 inch (2.54 cm) from the end of each spoke 44. Posts, pegs or studs 70 help hold the support basket in place.

The following is a list of parts and materials suitable for use in the present invention:

PARTS LIST

| Parts Number | Description |
|---|---|
| 10 | centrifugal separator |
| 12 | hopper |
| 14 | screen |
| 16 | arrow |
| 20 | slurry |
| 22 | arrow |
| 26 | circular space |
| 28 | outer wall |
| 30 | outer shaft |
| 40 | rotor |
| 42 | hub portion |
| 43 | wall |
| 44 | spokes or blades |
| 45 | outer ring |
| 46 | distal end |
| 48 | space |
| 50 | circular wall |
| 60 | arrow |
| 62 | arrow |
| 70 | post/peg/stud |

All measurements disclosed herein are at standard temperature and pressure, at sea level on Earth, unless indicated otherwise.

The foregoing embodiments are presented by way of example only; the scope of the present invention is to be limited only by the following claims.

1. A centrifugal separator system, comprising:
a. a chute for introducing material into the separator;
b. a screen rotated on a shaft for allowing a liquid portion of the material to flow through the screen but preventing solids from flowing through the screen;
c. a space between a housing and the screen for allowing solid material to travel through the separator;
d. a rotor having a plurality of spaced apart blades rotating on the shaft, for allowing the solid material to travel through the spaces between the rotating blades;
e. each of the blades being circular in cross section along at least a portion of their length to minimize the impact on the solid material which makes contact with the rotating blades and to reduce the fracturing of the solid material.

2. The centrifugal separator in claim 1, wherein the material is coal suspended in a slurry or having moisture on the surface of the solid material.

3. The centrifugal separator in claim 1, wherein the rotor and screen are rotating between 200 and 2000 RPM (3.34 to 33.34 hertz).

4. The centrifugal separator in claim 1, wherein the separator utilizes less energy due to the reduction of impact between the solid material and the circular wall of the rotor blades.

5. The centrifugal separator in claim 1, wherein the blades of the rotor radiate at a right angle from a hub portion of the rotor to an outer ring portion of the rotor to define the traveling space for the solid material between the rotor blades.

6. A centrifugal separator system, comprising:
a. a chute for introducing material, such as coal in a slurry, into the separator;
b. a screen rotated on a shaft for allowing a liquid portion of the material to flow through the screen but preventing solid material from flowing through the screen;
c. a space between a housing and the screen for allowing the solid material to travel through the separator;
d. a rotor portion, further comprising a plurality of blades radiating at a right angle from a hub portion of the rotor to an outer ring portion of the rotor to define the traveling space for the solid material between the rotor blades;
e. each of the blades being circular in cross section along at least a portion of their length to minimize the impact on that the solid which makes contact with the rotating blades and do less damage to the solid material.

7. The centrifugal separator in claim 6, wherein the material is coal suspended in a slurry or having moisture on the surface of the solid material.

8. The centrifugal separator in claim 6, wherein the rotor and screen are rotating between 200 and 2000 RPM (3.34 to 33.34 hertz).

9. The centrifugal separator in claim 6, wherein the separator utilizes less energy due to the reduction of impact between the solid material and the circular wall of the rotor blades.

10. The centrifugal separator in claim 6, wherein the blades of the rotor radiate at an oblique angle from a hub portion of the rotor to an outer ring portion of the rotor to define the traveling space for the solid material between the rotor blades.

11. The centrifugal separator in claim 1, wherein the blades of the rotor radiate at an angle less than a right angle from a hub portion of the rotor to an outer ring portion of the rotor to define the traveling space for the solid material between the rotor blades.

12. An improved centrifugal separator system for separating a solid portion from a liquid portion of a slurry, the system of the type including a chute for introducing material into the separator; a screen rotated on a shaft for allowing a liquid portion of the material to flow through the screen but preventing solids from flowing through the screen; a space between a housing and the screen for allowing the solids to travel through the separator; a rotor portion, further comprising a plurality of blades radiating outward from a hub portion of the rotor to an outer ring portion of the rotor to define the traveling space for the solid material between the rotor blades; wherein the improvement comprises:
each of the blades being circular in cross section along at least a portion of their length to minimize the impact on the solid material which makes contact with the rotating blades and do less damage to the solid material, resulting in better product and a reduction in the energy required to power the separator.

13. A method of separating solid coal from a liquid portion in a slurry, comprising the following steps:
a. providing a centrifugal separator;
b. introducing the coal slurry into the separator;
b. routing the slurry to a rotating screen in the separator allowing the liquid portion of the material to flow through the screen but preventing the solid coal from flowing through the screen;
c. providing a rotor portion, which further comprises a plurality of spaced apart blades, each of the blades being circular in cross section along at least a portion of their length;
d. flowing the solid coal through the spaces between the blades of the rotating rotor in the separator, so that the circular walls of the blades minimize the impact on the solid coal which makes contact with the rotating blades to reduce or eliminate fracturing to the pieces of solid coal.

14. The method in claim 13, wherein the rotor and screen are rotating between 200 and 2000 RPM (3.34 to 33.34 hertz).

15. The method in claim 13, wherein the blades being circular in cross section results in the utilization of less energy due to the reduction of impact between the solid coal and the circular wall of the blades.

16. The method in claim 13, wherein the rotor and screen rotate at an optimum speed of approximately 600 RPM (10 hertz).

17. The centrifugal separator system in claim 1, wherein the rotor and screen rotate at an optimum speed of approximately 600 RPM (10 hertz).

18. The centrifugal separator system in claim 6, wherein the rotor and screen rotate at an optimum speed of approximately 600 RPM (10 hertz).

19. The centrifugal separator system in claim 1, wherein the material may comprise any material that could be separated from a liquid, such as various minerals, oil field cuttings and other types of solids.

20. The method in claim 13, wherein the method further comprises separating any material that could be separated from a liquid, such as various minerals, oil field cuttings and other types of solids.

21. The centrifugal separator system in claim 6, wherein the material may comprise any material that could be separated from a liquid, such as various minerals, oil field cuttings and other types of solids.

22. The method in claim 13, wherein the rotor and screen rotate at an optimum speed of approximately 600 RPM (10 hertz).
